(19) United States
(12) Patent Application Publication
(10) Pub. No.: US 2024/0092683 A1
(43) Pub. Date: Mar. 21, 2024

(54) OPTICAL GLASS, NEAR-INFRARED CUT FILTER, GLASS ELEMENT FOR PRESS MOLDING, OPTICAL ELEMENT BLANK, AND OPTICAL ELEMENTS

(71) Applicant: HOYA CORPORATION, Tokyo (JP)

(72) Inventors: Katsuyuki MUKOGAWA, Tokyo (JP); Hironori OGUMA, Tokyo (JP)

(73) Assignee: HOYA CORPORATION, Tokyo (JP)

(21) Appl. No.: 18/521,037

(22) Filed: Nov. 28, 2023

Related U.S. Application Data
(63) Continuation of application No. PCT/JP2022/022061, filed on May 31, 2022.

(30) Foreign Application Priority Data
Jun. 1, 2021 (JP) 2021-092410

(51) Int. Cl. C03C 3/068; C03C 4/08; G02B 5/28

(52) U.S. Cl. CPC C03C 3/068; C03C 4/082; G02B 5/282

(57) ABSTRACT

An object is to provide an optical glass with a near-infrared absorbing function that maintains constant and high transmittance in a visible light range and also has excellent oblique incidence characteristics as well as excellent durability, heat resistance, and weather resistance, and to provide a near-infrared cut filter, a glass element for press molding, an optical element blank, and an optical element including the same. Provided is an optical glass including a glass composition as a base containing at least Yb₂O₃ and B₂O₃ as essential components, the optical glass characterized in that a content of Yb₂O₃ is 5% to 60% by mass, a content of B₂O₃ is 10% to 50% by mass, and when a thickness of the optical glass is 2.5 mm, average transmittance in a wavelength range of 925 to 955 nm is 0% to 70%, and average transmittance in a wavelength range of 965 to 985 nm is 0% to 50%.

### CLAIM FOR PRIORITY

This application is a Continuation of PCT/JP2022/022061 filed May 31, 2022, which is expressly incorporated by reference herein in its entirety.

### TECHNICAL FIELD

The present disclosure relates to subject matter contained in Japanese Patent Application No. 2021-092410 (filed on Jun. 1, 2021) which is expressly incorporated herein by reference in its entirety.

The present invention relates to an optical glass having excellent visible light transmissivity and excellent near-infrared light absorptivity, and to a near-infrared cut filter, a glass element for press molding, an optical element blank, and an optical element including the same.

### BACKGROUND ART

Autonomous driving technology for automobiles has been advancing quickly in recent years. In such autonomous driving technology, a LiDAR (Light Detection and Ranging) system is used since it is necessary to accurately recognize and range objects moving at high speed in a wide area around the host vehicle.

The LiDAR system is a remote sensing technology using light, and analyzes the distance to a distant object and properties of that object by applying a laser beam that emits pulsed light onto the object and measuring its scattered light beam. Such LiDAR systems generally use a laser beam in a 900-nm wavelength range (e.g., 905 nm, 940 nm, 970 nm) since it does not get easily affected by ambient light and direct sunlight.

Also, since autonomous driving of automobiles requires the ability to perform safe self-driving on freeways and ordinary roads, an imaging device incorporating a solid-state imaging element, such as a CCD (Charge Coupled Device) or a CMOS (Complementary Metal Oxide Semiconductor) is often used together with a LiDAR system to ensure sensing redundancy in the system.

In such an imaging device, the solid-state imaging element has spectral sensitivity in a near-ultraviolet to near-infrared range. Thus, when an imaging device is used with a LiDAR system, there is a problem that good color reproducibility cannot be obtained as a result of being affected by the laser beam from the LiDAR system.

For this reason, imaging devices have been proposed which include a near-infrared cut filter (optical filter) for blocking the laser beam of the LiDAR system.

Such near-infrared cut filters in practical use include one with a configuration in which a dielectric multilayer film is formed on a glass substrate and the dielectric multilayer film reflects light beams of predetermined wavelengths (near-infrared rays) (e.g., Patent Literature 1), and one with a configuration in which an absorption layer that absorbs near-infrared rays is formed on a glass substrate and the absorption layer absorbs light beams of predetermined wavelengths (near-infrared rays) (e.g., Patent Literature 2).

### CITATION LIST

### Patent Literature

Patent Literature 1: Japanese Patent No. 6194384
Patent Literature 2: International Publication No. WO2019/151344

### SUMMARY

### Technical Problem

With the configuration disclosed in Patent Literature 1, the dielectric multilayer film reflects light beams of predetermined wavelengths (near-infrared rays) in light incident on the near-infrared cut filter, and only light beams of desired wavelengths (visible light) are transmitted. Thus, the solid-state imaging element that receives the transmitted light beams provides an image with excellent color reproducibility.

However, when a LiDAR system and an imaging device are used simultaneously, the laser beam (near-infrared ray) from the LiDAR system is reflected by the dielectric multilayer film of the near-infrared cut filter, so that this reflected beam appear as noise in the LiDAR system and affects the measurement accuracy of the LiDAR system.

In addition, when light is obliquely incident on the dielectric multilayer film, the optical path length becomes longer, causing a phase shift. This causes problems such as shifting the spectral transmittance curve to the shorter wavelength side and causing ripples on the spectral transmittance curve. The wavelength shift occurring on the spectral transmittance curve leads to a problem such as deterioration in the color reproducibility of the solid-state imaging element. Also, the ripples appearing on the spectral transmittance curve lead to a problem such as a kind of ghost being observed on the solid-state imaging element.

Also, with the configuration disclosed in Patent Literature 2, the absorption layer absorbs light beams of predetermined wavelengths (near-infrared rays) in light incident on the near-infrared cut filter, and only light beams of desired wavelengths (visible light) are transmitted. Thus, the solid-state imaging device that receives the transmitted light beams provides an image with excellent color reproducibility.

Here, the absorption layer disclosed in Patent Literature 2 contains a near-infrared absorbing dye and a transparent resin, and has problems such as poor durability, heat resistance, and weather resistance. Also, LiDAR systems to be mounted on vehicles in particular require high reliability for outdoor use and safety. Hence, near-infrared cut filters for use in LiDAR systems are also required to have far higher durability, heat resistance, and weather resistance than conventional ones.

The present invention has been made in view of the above circumstances. Some embodiments provide an optical glass with a near-infrared absorbing function that maintains constant and high transmittance in a visible light range and also has excellent oblique incidence characteristics (i.e., very low incidence angle dependence) as well as excellent durability, heat resistance, and weather resistance, and to provide a near-infrared cut filter, a glass element for press molding, an optical element blank, and an optical element including the same.

### Solution to Problem

To achieve the above object, the present inventors have conducted intensive study. Focusing on the fact that Yb (ytterbium) absorbs a 900 nm range, the present inventors have found that, by adding the amount of Yb added, an optical glass that selectively absorbs near-infrared rays in a 900 nm range while also maintaining constant and high transmittance in a visible light range can be manufactured without using a dielectric multilayer film or an absorption layer used in conventional near-infrared cut filters. The present invention has been made based on this finding.

Specifically, an optical glass of one embodiment is an optical glass including a glass composition as a base containing at least Yb₂O₃ and B₂O₃ as essential components, the optical glass characterized in that a content of Yb₂O₃ is 5% to 60% by mass, a content of B₂O₃ is 10% to 50% by mass, and when a thickness of the optical glass is 2.5 mm, average transmittance in a wavelength range of 925 to 955 nm is 0% to 70%, and average transmittance in a wavelength range of 965 to 985 nm is 0% to 50%.

With such a constitution, the conventional dielectric multilayer film or absorption layer is not included. Thus, it is possible to obtain an optical glass with a near-infrared absorbing function that has excellent oblique incidence characteristics (i.e., very low incidence angle dependence) and also has excellent durability, heat resistance, and weather resistance and maintains constant and high transmittance in a visible light range.

Also, it is desirable that average transmittance in a wavelength range of 400 to 800 nm be 80% to 92%.

Also, it is desirable that a first wavelength at a point on a transmittance curve of the optical glass where transmittance decreases to 50% be 860 to 940 nm, and a second wavelength at a point on the transmittance curve where the transmittance increases to 50% be 970 to 1040 nm.

Also, it is desirable that a thickness of the optical glass be 0.5 to 5.0 mm.

Also, it is desirable that a liquidus temperature of the optical glass be 1350° C. or less.

Also, it is desirable that powder-method water resistance of the optical glass be class 1, 2, or 3.

Also, it is desirable that the glass composition contain SiO₂: 0% to 30%, Al₂O₃: 0% to 15%, MgO: 0% to 10%, CaO: 0% to 20%, SrO: 0% to 10%, BaO: 0% to 25%, ZnO: 0% to 25%, TiO₂: 0% to 15%, Nb₂O₅: 0% to 15%, Ta₂O₅: 0% to 7%, WO₃: 0% to 10%, ZrO₂: 0% to 10%, La₂O₃: 0% to 30%, Y₂O₃: 0% to 30%, Gd₂O₃: 0% to 30%, Sb₂O₃: 0% to 0.05%, and SO₃: 0% to 0.3% in terms of % by mass.

Also, it is desirable that the optical glass further contain at least one of Li₂O, Na₂O, and K₂O such that a total content thereof is within a range of more than 0% to 10% by mass or less. Also, in this case, it is desirable that the content of Yb₂O₃ be 30% by mass or more.

Also, it is desirable that a ratio of the content of Yb₂O₃ to a total of a Ln₂O₃ component (Ln is one or more selected from the group consisting of Yb, La, Y, and Gd) be 0.6 to 1.0.

Also, from another viewpoint, a near-infrared cut filter of one embodiment is characterized in that the near-infrared cut filter includes any one of the optical glasses described above.

Also, from another viewpoint, a glass element for press molding of one embodiment is characterized in that the near-infrared cut filter includes any one of the optical glasses described above.

Also, from another viewpoint, an optical element blank of one embodiment is characterized in that the near-infrared cut filter includes any one of the optical glasses described above.

Also, from another viewpoint, an optical element of one embodiment is characterized in that the near-infrared cut filter includes any one of the optical glasses described above.

As described above, according to some embodiments of the present invention, the conventional dielectric multilayer film or absorption layer is not included. Thus, it is possible to provide an optical glass with a near-infrared absorbing function that has excellent oblique incidence characteristics (i.e., very low incidence angle dependence) and also has excellent durability, heat resistance, and weather resistance and maintains constant and high transmittance in a visible light range. Moreover, it is possible to provide a near-infrared cut filter, a glass element for press molding, an optical element blank, and optical element including such an optical glass.

### BRIEF DESCRIPTION OF DRAWINGS

FIG. 1 is a diagram illustrating a spectral transmittance curve of an optical glass according to an embodiment of the present invention (Example 1).

FIG. 2 is a diagram illustrating a spectral transmittance curve of an optical glass according to an embodiment of the present invention (Example 2).

FIG. 3 is a diagram illustrating a spectral transmittance curve of an optical glass according to an embodiment of the present invention (Example 3).

FIG. 4 is a diagram illustrating a spectral transmittance curve of an optical glass according to an embodiment of the present invention (Example 4).

FIG. 5 is a diagram illustrating a spectral transmittance curve of an optical glass according to an embodiment of the present invention (Example 5).

FIG. 6 is a diagram illustrating a spectral transmittance curve of an optical glass according to an embodiment of the present invention (Example 6).

FIG. 7 is a diagram illustrating a spectral transmittance curve of an optical glass according to an embodiment of the present invention (Example 7).

FIG. 8 is a diagram illustrating a spectral transmittance curve of an optical glass according to an embodiment of the present invention (Example 8).

FIG. 9 is a diagram illustrating a spectral transmittance curve of an optical glass according to an embodiment of the present invention (Example 9).

FIG. 10 is a diagram illustrating a spectral transmittance curve of an optical glass according to an embodiment of the present invention (Example 10).

FIG. 11 is a diagram illustrating a spectral transmittance curve of an optical glass according to an embodiment of the present invention (Example 11).

FIG. 12 is a diagram illustrating a spectral transmittance curve of an optical glass according to an embodiment of the present invention (Example 12).

FIG. 13 is a diagram illustrating a spectral transmittance curve of an optical glass according to an embodiment of the present invention (Example 13).

FIG. 14 is a diagram illustrating a spectral transmittance curve of an optical glass according to an embodiment of the present invention (Example 14).

FIG. 15 is a diagram illustrating a spectral transmittance curve of an optical glass according to a comparative example of the present invention (Comparative Example 1).

### DESCRIPTION OF EMBODIMENT

An embodiment of the present invention will be described below in detail. An optical glass according to the embodiment of the present invention is a glass with a glass composition as a base containing at least Yb₂O₃ as an essential component, and has a near-infrared absorbing function to selectively absorb near-infrared rays in a 900 nm range in incident light (i.e., a band-stop filter function).

The glass composition can contain Yb₂O₃ and B₂O₃ as essential components and further contain SiO₂, Al₂O₃, Li₂O, Na₂O, K₂O, MgO, CaO, SrO, BaO, ZnO, TiO₂, Nb₂O₅, Ta₂O₅, WO₃, ZrO₂, La₂O₃, Y₂O₃, and Gd₂O₃ as necessary. A desired content range of each constituent component of the glass composition is as follows.

Yb₂O₃: 5 to 60%

B₂O₃: 10 to 50%

SiO₂: 0 to 30%

Al₂O₃: 0 to 15%

Li₂O: 0 to 10%

Na₂O: 0 to 10%

K₂O: 0 to 10%

MgO: 0 to 10%

CaO: 0 to 20%

SrO: 0 to 10%

BaO: 0 to 25%

ZnO: 0 to 25%

TiO₂: 0 to 15%

Nb₂O₅: 0 to 15%

Ta₂O₅: 0 to 7%

WO₃: 0 to 10%

ZrO₂: 0 to 10%

La₂O₃: 0 to 30%

Y₂O₃: 0 to 30%

Gd₂O₃: 0 to 30%

Sb₂O₃: 0 to 0.05%

SO₃: 0 to 0.3%

When the content of Yb₂O₃ is 25% or more, it is desirable to contain Al₂O₃ and SiO₂ as essential components, in which case Al₂O₃ and SiO₂ are desirably contained such that their total content is more than 0% to 32% or less.

When the content of Yb₂O₃ is 30% or more, it is desirable to contain an alkali metal(s) (Li₂O, Na₂O, K₂O) as an essential component(s) in addition to Al₂O₃ and SiO₂, in which case at least one of Li₂O, Na₂O, and K₂O is contained such that their total content is 10% or less.

Also, the ratio of the content of Yb₂O₃ to the total of a rare-earth Ln₂O₃ component (where Ln is one or more selected from the group consisting of Yb, La, Y, and Gd) is within the range of 0.6 to 1.0.

The contents of the components are all represented as % by mass with respect to the total mass of the glass represented as the constitution in terms of oxide. Here, the constitution in terms of oxide refers to a constitution in which, assuming that oxides, composite salts, metal fluorides, and the like used as raw materials of the constituent components of the glass in the present invention are decomposed and converted into oxides during melting, each component contained in the glass is expressed with the total mass of the oxides thus generated being 100% by mass.

The glass constitution in the present invention can be quantified by a method such as ICP-AES (Inductively Coupled Plasma-Atomic Emission Spectrometry), for example. The analysis values obtained by ICP-AES may contain ±5% of the analysis values as measurement errors. Also, in the specification and the present invention, when the content of a constituent component is 0% or this constituent component is not contained or not introduced, it means that the constituent component is not substantially contained or the content of the constituent component is less than or equal to the content of an impurity.

In the following, (more) preferable lower limits and (more) preferable upper limits of numerical ranges may be shown in tables and described. In the tables, a numerical value listed at a lower position is more preferable, and the numerical value list at the lowermost position is the more preferable. Further, unless otherwise noted, a (more) preferable lower limit means that being more than or equal to the listed value is (more) preferable, and a (more) preferable upper limit means that being less than or equal to the listed value is (more) preferable. Numerical values listed in a (more) preferred lower limit column and a numerical value listed in a (more) preferred upper limit column in a table can be combined as desired to define a numerical range.

Yb₂O₃, La₂O₃, Y₂O₃, and Gd₂O₃ function to improve the chemical durability and weather resistance of the glass and raise the glass transition temperature. Also, of Yb₂O₃, La₂O₃, Y₂O₃, and Gd₂O₃, Yb₂O₃ is a rare-earth element that absorbs near-infrared rays with wavelengths of 860 to 1030 nm. When the content of Yb₂O₃ is less than 5%, the near-infrared absorbing function significantly drops. When the content of Yb₂O₃ is 5% or more, a near-infrared absorbing function corresponding to the content is obtained. This makes it possible to prepare a glass having the above-described optical characteristics. On the other hand, Yb₂O₃ increases the tendency of devitrification when its content is more than 60%, but enhances the thermal stability when the content is 60% or less. This makes it possible to suppress crystallization when the glass is manufactured, and to reduce raw materials left unmelted when the glass is melted. Thus, the range of Yb₂O₃ in the glass is preferably 5% to 60%, more preferably 10% to 57%, more preferably 13% to 55%, more preferably 16% to 53%, more preferably 18% to 51%, and further preferably 20% to 50%. Note that in the present embodiment, from the viewpoint of satisfying both the chemical durability and the weather resistance, the ratio of the content of Yb₂O₃ to the total of the rare-earth Ln₂O₃ component (where Ln is one or more selected from the group consisting of Yb, La, Y, and Gd) is adjusted to be within the range of 0.6 to 1.0.

B₂O₃ is a component that functions to improve the thermal stability and meltability of the glass. On the other hand, B₂O₃ tends to lower the viscosity of the molten glass to be molded when its content is large. In order to achieve desired optical characteristics while also maintaining the thermal stability and meltability of the glass well, the range of B₂O₃ is preferably 10% to 50%, more preferably 12% to 48%, and further preferably 14% to 46%.

SiO₂ is a component which is effective in improving the thermal stability and chemical durability of the glass and adjusting the viscosity of the molten glass to be molded. On the other hand, SiO₂ makes raw materials of the glass prone to remain unmelted at the time of melting the glass, that is, tends to lower the meltability of the glass when its content is large. In order to achieve desired optical characteristics while maintaining the thermal stability and meltability of the glass well, the range of SiO₂ is preferably 0% to 30%, more preferably 0% to 28%, and further preferably 0% to 25%. The content of SiO₂ can be 0%.

Al₂O₃ is a component that can function to improve the thermal stability and chemical durability of the glass. In order to prevent a raise in liquidus temperature and a decrease in devitrification resistance while also improving the thermal stability and chemical durability of the glass, the range of Al₂O₃ is preferably 0% to 15%, more preferably 0% to 13%, and more preferably 0% to 11%. The content of Al₂O₃ can be 0%.

Li₂O functions to improve the meltability of the glass and the moldability of the glass. On the other hand, Li₂O may lower the thermal stability of the glass when its content is large. Thus, the range of the content of Li₂O is preferably 0% to 10%, more preferably 0% to 8%, more preferably 0% to 6%, and further preferably 0% to 5%.

Na₂O functions to improve the meltability of the glass and the moldability of the glass. On the other hand, Na₂O may lower the thermal stability of the glass when its content is large. Thus, the range of the content of Na₂O is preferably 0% to 10%, more preferably 0% to 8%, more preferably 0% to 6%, and further preferably 0% to 5%.

K₂O functions to improve the meltability of the glass. On the other hand, K₂O may lower the thermal stability of the glass when its content is large. Thus, the range of the content of K₂O is preferably 0% to 10%, more preferably 0% to 8%, more preferably 0% to 6%, and further preferably 0% to 5%.

MgO is a component that functions to improve the meltability of the glass. On the other hand, MgO tends to lower the stability of the glass when its content is large. Thus, the range of the content of MgO is preferably 0% to 10%, more preferably 0% to 9%, and further preferably 0% to 8%. The content of MgO can be 0%.

CaO is a component that improves the meltability of the glass. On the other hand, CaO tends to lower the stability of the glass when its content is large. Thus, the range of the content of CaO is preferably 0% to 20%, more preferably 0% to 18%, and further preferably 0% to 15%. The content of CaO can be 0%.

SrO is a component that functions to improve the meltability of the glass. On the other hand, SrO tends to lower the stability of the glass when its content is large. Thus, the range of the content of SrO is preferably 0% to 10%, more preferably 0% to 9%, and further preferably 0% to 8%. The content of SrO can be 0%.

BaO is a component that functions to improve the meltability of the glass. On the other hand, BaO tends to lower the stability of the glass when its content is large. Thus, the range of the content of BaO is preferably 0% to 25%, more preferably 0% to 22%, and further preferably 0% to 19%. The content of BaO can be 0%.

ZnO is a component that functions to improve the meltability of raw materials of the glass at the time of melting the glass, and improves mechanical workability. On the other hand, ZnO tends to lower the viscosity of the molten glass to be molded when its content is large. Thus, the range of the content of ZnO is preferably 0% to 25%, more preferably 0% to 22%, and further preferably 0% to 19%. The content of ZnO can be 0%.

TiO₂ is a component that functions to improve the thermal stability of the glass. On the other hand, TiO₂ causes the optical absorption edge of the spectral transmittance on the short wavelength side to shift toward the long wavelength side when its content is large. Accordingly, the wavelength at the optical absorption edge on the short wavelength side gets longer. Thus, the range of the content of TiO₂ is preferably 0% to 15%, more preferably 0% to 13%, and further preferably 0% to 11%. The content of TiO₂ can be 0%.

Nb₂O₅ is a component that functions to improve the thermal stability of the glass, and is a component with which the wavelength at the optical absorption edge of the glass on the short wavelength side is less likely to get longer as compared to TiO₂ and WO₃. Thus, the range of the content of Nb₂O₅ is preferably 0% to 15%, more preferably 0% to 13%, and further preferably 0% to 11%. The content of Nb₂O₅ can be 0%.

Ta₂O₅ is an expensive component, and functions to increase the relative density of the glass. Thus, in order to lower the production cost of the glass for stable supply of the glass and also to avoid an increase in relative density, the range of the content of Ta₂O₅ is preferably 0% to 15%, more preferably 0% to 13%, and further preferably 0% to 11%. The content of Ta₂O₅ can be 0%.

WO₃ is a component that functions to improve the thermal stability of the glass. On the other hand, WO₃ causes the optical absorption edge of the spectral transmittance on the short wavelength side to shift toward the long wavelength side when its content is large. Accordingly, the wavelength at the optical absorption edge on the short wavelength side gets longer. Thus, the range of the content of WO₃ is preferably 0% to 10%, more preferably 0% to 8%, and further preferably 0% to 6%. The content of WO₃ can be 0%.

ZrO₂ is a component that functions to improve the thermal stability of the glass. ZrO₂ also functions to raise the glass transition temperature to thereby make the glass resistant to breaking when subjected to a mechanical process. On the other hand, ZrO₂ causes crystallization and incomplete melting during the manufacturing of the glass when its content added is large. Thus, the range of the content of ZrO₂ is preferably 0% to 10%, more preferably 0% to 9%, and further preferably 0% to 8%. The content of ZrO₂ can be 0%.

La₂O₃ is a component that tends not to lower the thermal stability even when its content is large, as compared to Y₂O₃, Gd₂O₃, and Yb₂O₃. On the other hand, La₂O₃ is also a rare-earth component that does not absorb near-infrared rays with wavelengths of 860 to 1030 nm like Yb₂O₃. Thus, the range of the content of La₂O₃ is preferably 0% to 30%, more preferably 0% to 27%, more preferably 0% to 25%, and further preferably 0% to 23%. The content of La₂O₃ can be 0%.

Y₂O₃ is a component that functions to improve the thermal stability of the glass. On the other hand, Y₂O₃ is also a rare-earth component that does not absorb near-infrared rays with wavelengths of 860 to 1030 nm like Yb₂O₃. Thus, the range of the content of Y₂O₃ is preferably 0% to 30%, more preferably 0% to 27%, more preferably 0% to 25%, and further preferably 0% to 23%. The content of Y₂O₃ can be 0%.

Gd₂O₃ is a component that functions to improve the thermal stability of the glass. On the other hand, among the components of the glass, Gd₂O₃ is a component that raises the relative density of the glass and is a rare-earth component that does not absorb near-infrared rays with wavelengths of 860 to 1030 nm like Yb₂O₃. Thus, the content of Gd₂O₃ is preferably 0% to 30%, more preferably 0% to 27%, more preferably 0% to 25%, and further preferably 0% to 23%. The content of Gd₂O₃ can be 0%.

Pb, As, Cd, Tl, Be, and Se are each toxic. It is therefore preferable that these elements not be contained, that is, these elements not be introduced into the glass as components of the glass. U, Th and Ra are each a radioactive element. It is therefore preferable that these elements not be contained, that is, these elements not be introduced into the glass as components of the glass. V, Cr, Mn, Fe, Co, Ni, Cu, Pr, Nd, Pm, Sm, Eu, Tb, Dy, Ho, Er, Tm, and Ce are not preferable as elements to be contained in glasses for optical elements since they increase staining of the glasses and act as sources of fluorescence. It is therefore preferable that these elements not be contained, that is, these elements not be introduced into the glass as components of the glass.

Sb₂O₃ is a component that can be added as a clarificant. While adding Sb₂O₃ only in a small amount can prevent a decrease in light transmittance due to inclusion of impurities such as Fe, adding Sb₂O₃ in a large amount tends to increase staining of the glass. Thus, the range of the content of Sb₂O₃ is preferably 0% to 0.5%, more preferably 0% to 0.4%, and more preferably 0% to 0.3%. The content of Sb₂O₃ can be 0%.

S is a component that can be added as a clarificant. On the other hand, S tends to cause the molten glass to bubble over and increase staining of the glass when its amount added is large. Thus, the range of the content of S in terms of SO₃ is preferably 0% to 0.3%, more preferably 0% to 0.2%, and more preferably 0% to 0.1%. The content of S can be 0%.

Also, in addition to S, Ce oxide, Sn oxide, nitrates, chloride, and fluorides can be added in small amounts as clarificants.

As described above, optical glasses according to some embodiments of the present invention contain a glass composition as a base containing at least Yb₂O₃ and B₂O₃ as essential components, and contain the other components described above as optional components. Here, there is a problem that the tendency of devitrification rises when the content of Yb₂O₃ is large (e.g., 25% or more).

For this reason, in some embodiments of the present invention, the total of the contents of Al₂O₃ and SiO₂ is reduced and the content of Yb₂O₃ is increased.

Specifically, based on the finding that the content of Yb₂O₃ can be increased with the total content of Al₂O₃ and SiO₂ set to be more than 0% to improve the thermal stability of the glass, the constitution is set such that the total content of Al₂O₃ and SiO₂ (i.e., the total of the content of Al₂O₃ and the content of SiO₂) is 32% or less when the content of Yb₂O₃ is 25% or more.

In this way, it is possible to improve the thermal stability of the glass and keep the glass from easily devitrifying when the glass is manufactured.

Note that in some embodiments of the present invention, the range of the total content of Al₂O₃ and SiO₂ is preferably more than 0% to 32%, more preferably more than 2% to 30%, and further preferably more than 4% to 25%.

As described above, the optical glass according to the present embodiment contains a glass composition as a base containing at least Yb₂O₃, B₂O₃, Al₂O₃, and SiO₂ as essential components, and contains the other components described above as optional components. Here, there is a problem that the tendency of devitrification further rises when the content of Yb₂O₃ is larger (e.g., 30% or more).

For this reason, in some embodiments of the present invention, alkali metals (Li₂O, K₂O, Na₂O) are added and the content of Yb₂O₃ is increased.

Specifically, based on the finding that the content of Yb₂O₃ can be increased with the total content of Li₂O, Na₂O, and K₂O set to be more than 0% to improve the meltability of the glass, the constitution is set such that at least one selected from the group consisting of Li₂O, Na₂O, and K₂O is contained as an essential component and the total content of Li₂O, Na₂O, and K₂O (i.e., the total of the content of Li₂O, the content of Na₂O, and the content of K₂O) is 10% or less in a case where the content of Yb₂O₃ is 30% or more. In this way, it is possible to improve the thermal stability of the glass and keep the glass from easily devitrifying when the glass is manufactured.

The range of the total content of Li₂O, Na₂O, and K₂O is preferably more than 0% to 10%, more preferably more than 0% to 9%, more preferably more than 0% to 8%, and further preferably more than 0% to 5%.

Note that Yb₂O₃ is a component that is effective in providing a glass having improved thermal stability and a near-infrared absorbing function when added in an amount which is appropriate for the total content of the rare-earth elements. Thus, as for Yb₂O₃, the range of the mass ratio of the content of Yb₂O₃ to the total content of Yb₂O₃, La₂O₃, Y₂O₃, and Gd₂O₃ (Yb₂O₃/(Yb₂O₃, La₂O₃, Y₂O₃, and Gd₂O₃)) is preferably 0.35% to 1%, more preferably 0.5% to 1%, further preferably 0.60% to 1%, and further preferably 0.7% to 1%.

Light incident on the optical glass according to the present embodiment is absorbed by the rare-earth element that absorbs near-infrared rays (Yb₂O₃) when passing through the optical glass and only near-infrared rays in a 900 nm range attenuate and exit. Thus, the spectral transmission characteristics of the optical glass can be explained with the so-called Lambert-Beale law, and are determined by the concentration of the rare-earth element that absorbs near-infrared rays (Yb₂O₃). Specifically, the optical glass according to the present embodiment is one in which the concentration of the rare-earth element that absorbs near-infrared rays (Yb₂O₃) is adjusted to obtain such spectral transmission characteristics that the transmittance is maintained constant and high in a visible range and abruptly attenuates in a 900 nm range.

### (Method of Manufacturing Glass (Near-Infrared Cut Filter Glass))

The above-described glass can be obtained by weighing and blending raw materials such as oxides, carbonates, sulfates, nitrates, and hydroxides to obtain a desired glass constitution, mixing them thoroughly to make a mixture batch, heating and melting the mixture batch in a melting vessel, defoaming and agitating the mixture batch to make a homogeneous and bubble-free molten glass, and molding it. Specifically, the above-described glass can be made using a publicly known melting method. The above-described glass is a near-infrared cut filter glass having the above-described optical characteristics yet has excellent thermal stability, and can therefore be stably manufactured using a publicly known melting method and molding method.

### (Glass Material for Press Molding, Optical Element Blank, and Methods of Manufacturing These)

Also, the above-described glass can be used for a glass material for press molding and an optical element blank.

A glass material for press molding can be obtained by molding the above-described glass into the glass material for press molding.

Also, an optical element blank can be obtained by performing press molding on the above glass material for press molding by using a mold for press molding.

An optical element blank can be obtained also by molding the above-described glass into the optical element blank.

An optical element blank is an optical element base material which has a similar shape to that of a target optical element and includes a polishing margin (a surface layer to be polished by grinding) and if necessary a grinding margin (a surface layer to be removed by grinding) added to the shape of the optical element. The optical element is finished by grinding and polishing the surface of the optical element blank. In one approach, an optical element blank can be prepared by a method in which a molten glass obtained by melting an appropriate amount of the above-described glass is press-molded (which is called direct pressing). In another approach, an optical element blank can be prepared by solidifying a molten glass obtained by melting an appropriate amount of the above-described glass.

A glass material for press molding can be press-molded by a publicly known method in which the glass material for press molding heated and softened is pressed with a mold for press molding. The heating and the press molding can both be performed in the atmosphere. By performing annealing after the press molding, the strain within the glass is reduced. In this way, a homogeneous optical element blank can be obtained.

A glass material for press molding includes what is called a glass gob for press molding which is to be press-molded as is to prepare an optical element blank, and also includes a glass gob for press molding which is to be press-molded after mechanical processes such as cutting, grinding, and polishing. The cutting method includes a method in which grooves are formed by a method called scribing in portions of a surface of a glass plate along which to cut the glass plate, and the glass plate is split along the grooved portions by locally applying a pressure to the grooved portions from the back of the surface in which the grooves are formed, a method in which the glass plate is cut with a cutting blade, and the like. Also, the grinding and polishing method includes barrel polishing and the like.

A glass material for press molding can be prepared by, for example, pouring a molten glass into a casting die to mold it into a glass plate, and cutting this glass plate into a plurality of glass pieces. Alternatively, a glass gob for press molding can be prepared by molding an appropriate amount of a molten glass. An optical element blank can be prepared by reheating a glass gob for press molding to soften it and press-molding it. The method in which an optical element blank is prepared by reheating glass to soften it and press-molding it is called reheat pressing as opposed to direct pressing.

### (Optical Element and Method of Manufacturing Same)

The above-described glass can also be used for an optical element.

An optical element can be obtained by, for example, grinding and/or polishing the above-described optical element blank.

Incidentally, a publicly known method may be used for the grinding and the polishing. After being processed, the surface of the optical element may be thoroughly washed and dried, for example. In this way, an optical element with high internal quality and surface quality can be obtained. Examples of the optical element may include various lenses such as spherical lenses, aspherical lenses, and microlenses, prisms, and the like.

### EXAMPLES

The optical glass according to the present embodiment will be further described below based on examples (Examples 1 to 14) and comparative examples (Comparative Examples 1 to 3). However, the present invention is not limited to these examples.

### (Method of Preparing Optical Glasses)

Silica stone powder, boric acid, oxides, hydroxides, carbonates, nitrates, sulfates, and the like were used as raw materials. For each of the examples and the comparative examples, these raw materials were weighed and thoroughly mixed to be a raw material blend with the corresponding glass constitution in Table 1, 2, or 3. The raw material blend thus obtained was placed in a platinum crucible, heated at approximately 1300° C. to 1450° C., and melted, clarified, and agitated for 2 to 3 hours to obtain a homogenized molten glass. The molten glass was poured into a preheated molding die, rapidly cooled, kept at temperatures around the glass transition temperature for 2 hours, and then the temperature was dropped at a drop rate of −30° C./hour. In this way, samples of the optical glasses in Examples 1 to 8 and 10 to 14 and Comparative Examples 1 and 3 were prepared.

Note that Example 9 is an example of a case where the content of Yb₂O₃ is 45%, and represents a glass constitution used to simulate spectral transmission characteristics to be described later. Also, Comparative Example 2 represents a simulated constitution in a case where the content of Yb₂O₃ is 50%.

Also, “Yb₂O₃/Ln₂O₃” in Tables 1 to 3 indicates the ratio of the content of Yb₂O₃ to the total of the rare-earth Ln₂O₃ component (where Ln is one or more selected from the group consisting of Yb, La, Y, and Gd) in Examples 1 to 14 and Comparative Examples 1 to 3.

| | Example 1 | Example 2 | Example 3 | Example 4 | Example 5 | Example 6 | Example 7 |
|---|---|---|---|---|---|---|---|
| Component | wt % | wt % | wt % | wt % | wt % | wt % | wt % |
| SiO₂ | 5.00 | 4.67 | 5.00 | 15.00 | 25.00 | 10.00 | 18.00 |
| Al₂O₃ | 2.00 | 1.87 | 2.00 | 7.00 | 5.00 | 3.00 | |
| B₂O₃ | 37.08 | 34.62 | 37.08 | 20.00 | 16.00 | 30.00 | 27.62 |
| CaO | 9.60 | 8.96 | 9.60 | 9.60 | 5.60 | | 18.36 |
| BaO | | | | 10.00 | 15.00 | 13.36 | |
| ZnO | 13.39 | 12.51 | 13.39 | 13.40 | 11.40 | 9.60 | |
| Li₂O | | | | | | | |
| La₂O₃ | | | 6.30 | | | 15.00 | 4.00 |
| Y₂O₃ | | | | | | 5.00 | 14.00 |
| Gd₂O₃ | | | | | | 9.00 | 4.00 |
| Yb₂O₃ | 32.88 | 37.28 | 26.64 | 24.96 | 21.96 | 5.00 | 14.00 |
| Sb₂O₃ | 0.05 | | | 0.04 | 0.04 | 0.04 | 0.02 |
| SO₃ | | 0.10 | | | | | |
| Total | 100.00 | 100.00 | 100.00 | 100.00 | 100.00 | 100.00 | 100.00 |
| Yb₂O₃/Ln₂O₃ | 1.00 | 1.00 | 0.81 | 1.00 | 1.00 | 0.15 | 0.39 |

| | Example 8 | Example 9 | Example 10 | Example 11 | Example 12 | Example 13 | Example 14 |
|---|---|---|---|---|---|---|---|
| Component | wt % | wt % | wt % | wt % | wt % | wt % | wt % |
| SiO₂ | 9.00 | 8.43 | 9.00 | 9.00 | 9.00 | 9.00 | 10.50 |
| Al₂O₃ | 11.00 | 4.82 | 11.00 | 11.00 | 11.00 | 8.00 | 6.00 |
| B₂O₃ | 28.00 | 24.09 | 28.00 | 28.00 | 28.00 | 28.00 | 30.00 |
| CaO | | 10.04 | | 5.00 | 7.00 | 12.50 | 12.50 |
| BaO | | | | | | | |
| ZnO | | | | | | | |
| Li₂O | 1.00 | 0.40 | 1.00 | 1.00 | 1.00 | 1.00 | 0.50 |
| La₂O₃ | 9.98 | 7.20 | 6.98 | 9.98 | 9.98 | 9.98 | 8.88 |
| Y₂O₃ | | | 3.00 | | | | |
| Gd₂O₃ | | | | | | | |
| Yb₂O₃ | 41.00 | 45.00 | 41.00 | 36.00 | 34.00 | 31.50 | 31.50 |
| Sb₂O₃ | 0.02 | 0.02 | 0.02 | 0.02 | 0.02 | 0.02 | 0.02 |
| SO₃ | | 0.10 | | | | | 0.10 |
| Total | 100.00 | 100.00 | 100.00 | 100.00 | 100.00 | 100.00 | 100.00 |
| Yb₂O₃/Ln₂O₃ | 0.80 | 0.86 | 0.80 | 0.78 | 0.77 | 0.76 | 0.78 |

| | Comparative | Comparative | Comparative |
|---|---|---|---|
| | Example 1 | Example 2 | Example 3 |
| Component | wt % | wt % | wt % |
| SiO₂ | 5.00 | 7.66 | 9.00 |
| Al₂O₃ | 2.00 | 4.38 | 11.00 |
| B₂O₃ | 37.08 | 21.90 | 28.00 |
| CaO | 9.60 | 9.12 | |
| BaO | | | |
| ZnO | 13.39 | | |
| Li₂O | | 0.36 | |
| La₂O₃ | | 6.57 | 10.98 |
| Y₂O₃ | | | |
| Gd₂O₃ | | | |
| Yb₂O₃ | 32.88 | 50.00 | 41.00 |
| Sb₂O₃ | 0.05 | 0.01 | 0.02 |
| SO₃ | | | |
| Total | 100.00 | 100.00 | 100.00 |
| Yb₂O₃/Ln₂O₃ | 1.00 | 0.88 | 0.79 |

### (Evaluation of Spectral Transmittance of Optical Glasses)

The spectral transmittance of the optical glasses in Examples 1 to 14 and Comparative Example 1 was evaluated. Note that the sample in Comparative Example 3 devitrified, and therefore its spectral transmittance was not evaluated. Also, the sample in Comparative Example 2 devitrified in the simulation, and therefore its spectral transmittance was not evaluated.

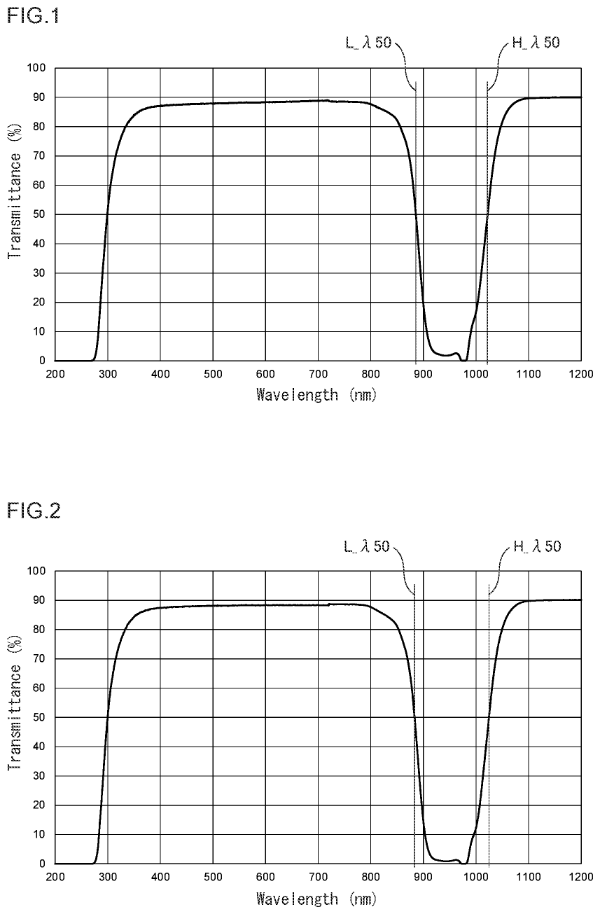

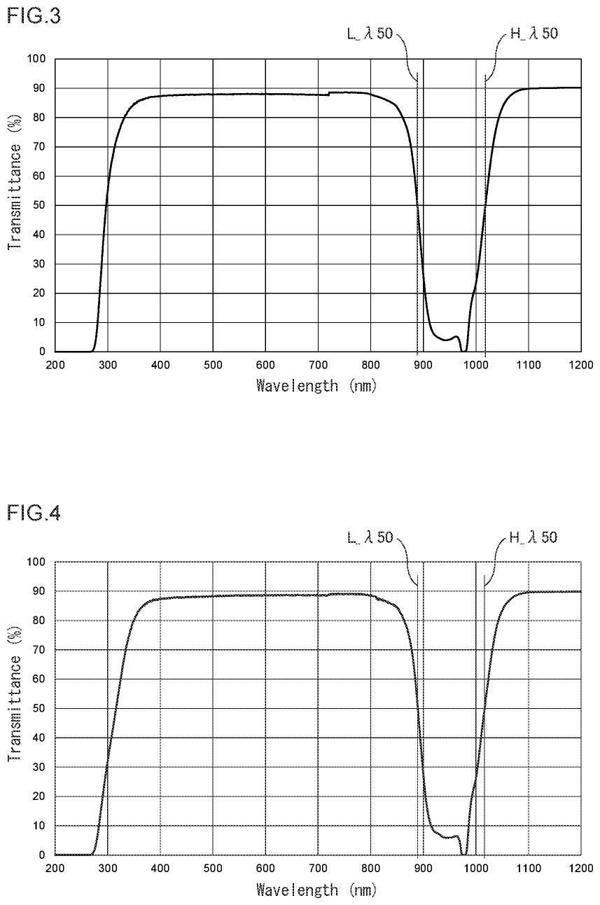

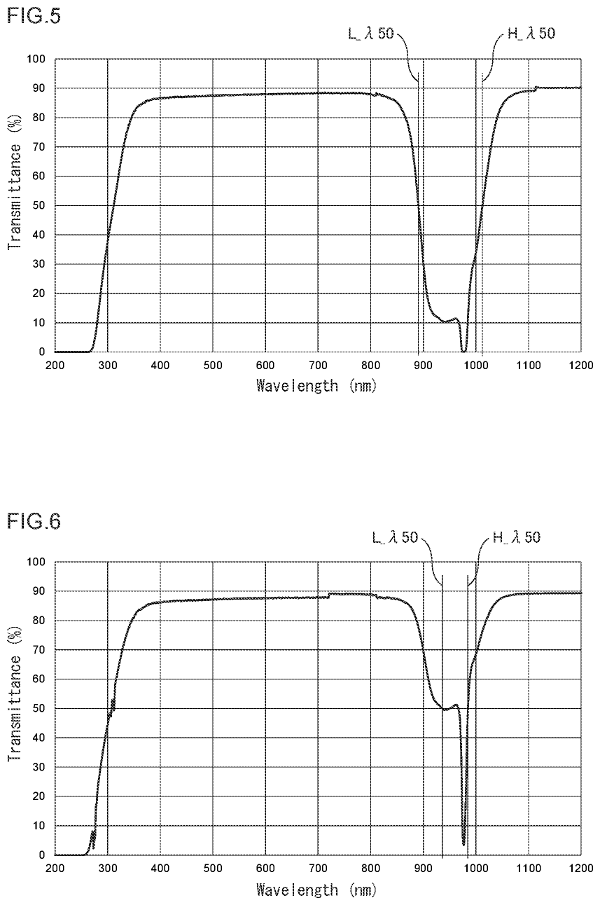

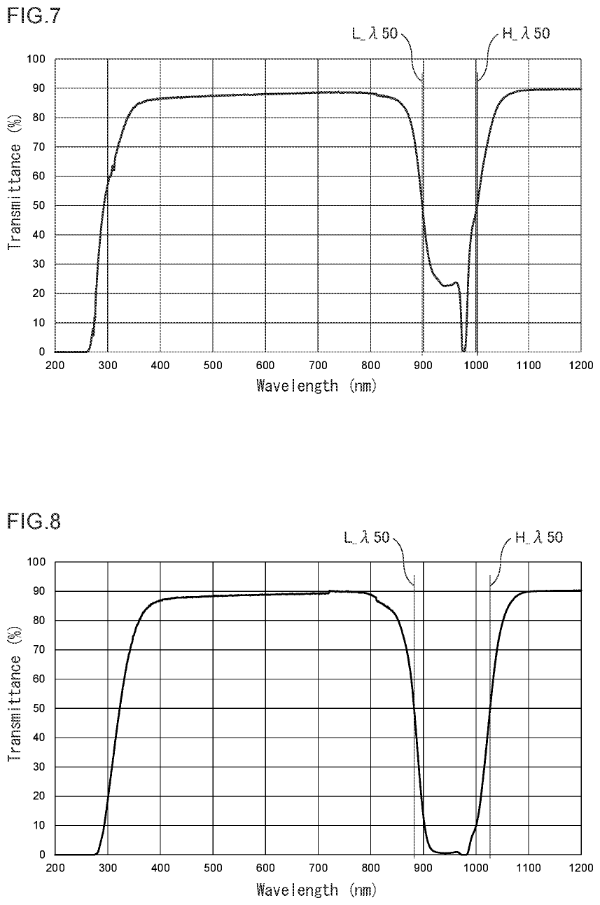

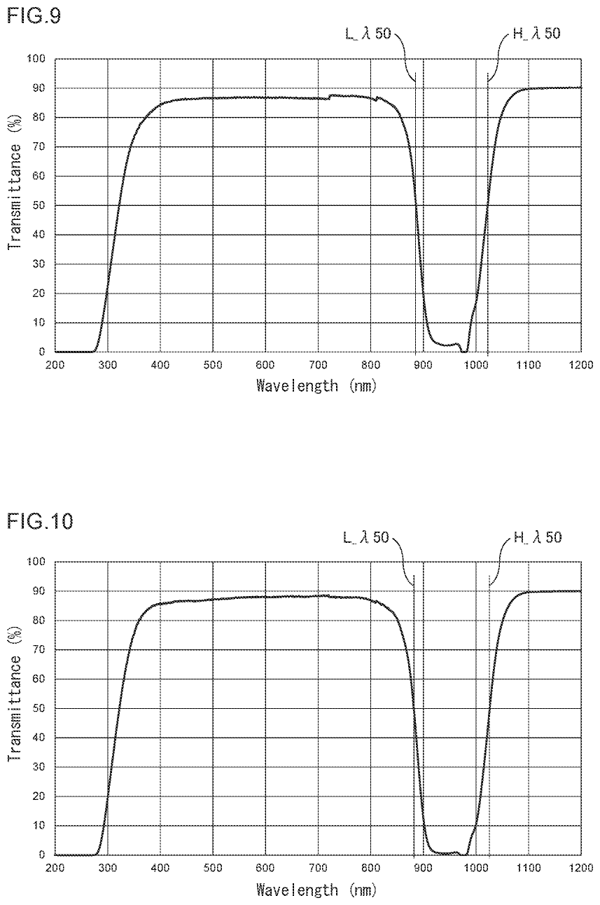

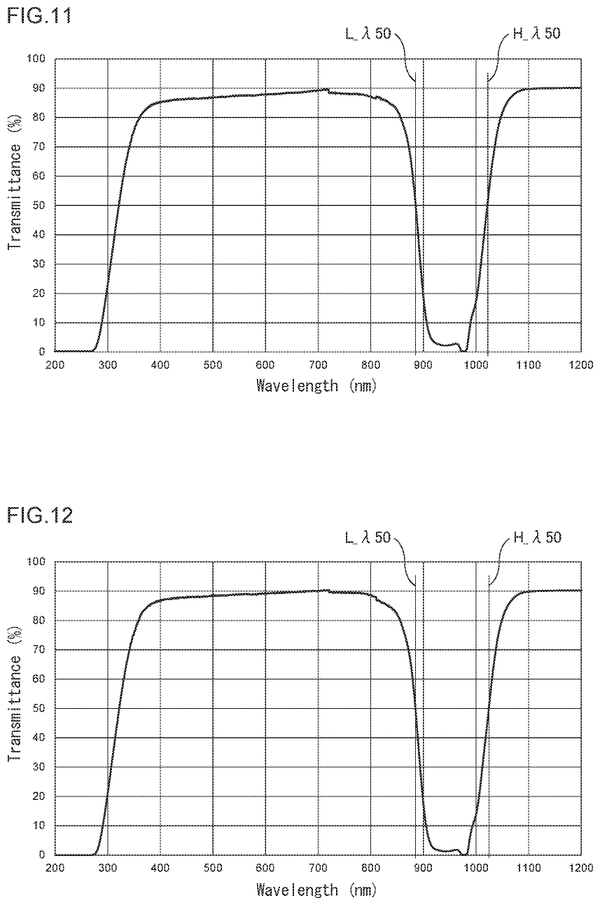

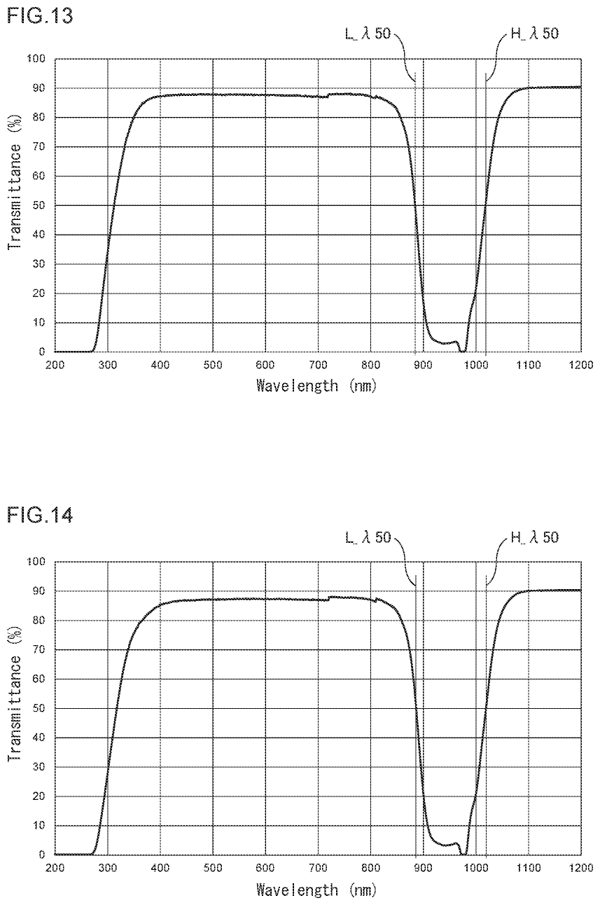

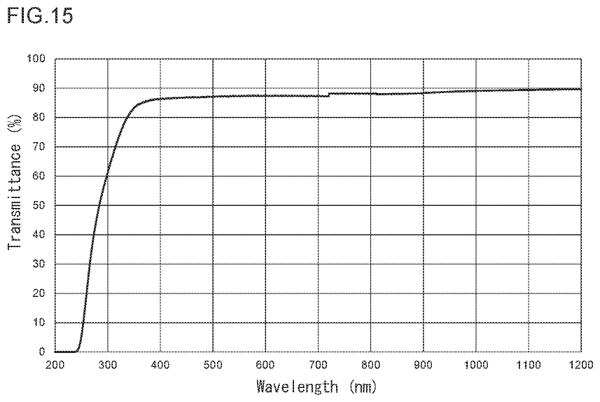

FIGS. 1 to 14 are graphs illustrating spectral transmittance curves of the optical glasses in Examples 1 to 14 with a thickness of 2.5 mm. Also, FIG. 15 is a graph illustrating a spectral transmittance curve of the optical glass in Comparative Example 1 with a thickness of 2.5 mm. Note that the vertical axes in FIGS. 1 to 15 represent the transmittance (%), and the horizontal axes represent the wavelength (nm). Incidentally, in the measurement in FIGS. 1 to 15, the optical glasses in Examples 1 to 14 and Comparative Example 1 were subjected to optical polishing on both surfaces to a thickness of 2.5±0.1 mm. With a spectrophotometer, a light beam with an intensity Iin was caused to perpendicularly enter a polished surface, and intensity Iout of the light beam having passed through the sample was measured, and spectral transmittance Iout/Iin was calculated. Also, in FIGS. 1 to 15, “L_λ50” indicates a half-value wavelength at a point where the transmittance decreases to 50% (first wavelength) on the spectral transmittance curves of the optical glasses in Examples 1 to 14 and Comparative Example 1, and “H_λ50” indicates a half-value wavelength at a point where the transmittance increases to 50% (second wavelength) on the spectral transmittance curves of the optical glasses in Examples 1 to 14 and Comparative Example 1.

### (Evaluation of Stability of Optical Glasses)

The optical glasses in Examples 1 to 14 and Comparative Example 1 were evaluated using “liquidus temperature (LT): ° C.” of the optical glasses as a stability indicator. Specifically, 10 cc (10 ml) of each sample (samples of the optical glasses in Examples 1 to 14 and Comparative Example 1) was introduced into a platinum crucible, melted for 20 to 30 minutes at 1250° C. to 1350° C., and then cooled down to a glass transition temperature Tg or below. The platinum crucible with the sample therein was then placed in a melting furnace at a predetermined temperature and held therein for 2 hours. The holding temperature was 1000° C. or higher at intervals of 20° C. or 30° C., and the lowest temperature without deposition of crystals after the 2-hour hold was defined as “liquidus temperature (LT): ° C.”. If the liquidus temperature is excessively high, devitrification will tend to occur during the manufacturing. Thus, the liquidus temperature is preferably 1350° C. or less, more preferably 1200° C. or less, and most preferably 1100° C. or less.

### (Evaluation of Chemical Durability of Optical Glasses)

The optical glasses in Examples 1 to 14 and Comparative Examples 1 to 3 were evaluated using “powder-method water resistance (Dw): class” as a chemical durability indicator. “Powder-method water resistance (Dw): class” is specified in the Japan Optical Glass Manufacturers' Association standard: JOGIS06-1999. Specifically, each powder sample (samples of the optical glasses in Examples 1 to 14 and Comparative Example 1: particle size=425 to 600 μm) of a mass corresponding to its relative density was put in a platinum basket, which was immersed in 80 ml of pure water (pH=6.5 to 7.5) held in a quartz-glass round-bottom flask and processed in a boiling-water bath for 60 minutes. Based on the rate of the decrease (%), the sample was classified as one of six classes: class 1 (<0.05%), class 2 (≥0.05 to <0.10%), class 3 (≥0.10 to <0.25%), class 4 (≥0.25 to <0.60%), class 5 (≥0.60 to <1.10%), and class 6 (≥1.10%). If the chemical durability is extremely poor, the glass will be difficult to use as an optical glass. In particular, considering using the optical glass of the present invention for a LiDAR system mounted on a vehicle, “powder-method water resistance (Dw): class” is preferably class 1 to 3, more preferably class 1 to 2, and most preferably class 1.

### (Evaluation Results and Discussion)

Tables 4 to 6 are tables indicating the average values (%) of the transmittance of the optical glasses in Examples 1 to 14 and Comparative Example 1 illustrated in FIGS. 1 to 15 in the wavelength range of 925 to 955 nm, the average values (%) of the transmittance of the optical glasses in the wavelength range of 965 to 985 nm, the average values (%) of the transmittance of the optical glasses in the wavelength range of 400 to 800 nm, the half-value wavelengths at the point where the transmittance decreases to 50% on the spectral transmittance curves of the optical glasses (“L_λ50”: nm), the half-value wavelengths at the point where the transmittance increases to 50% on the spectral transmittance curves of the optical glasses (“H_λ50”: nm), “liquidus temperature (LT): ° C.” and “powder-method water resistance (Dw): class” in Examples 1 to 14 and Comparative Examples 1 to 3.

| | Example | Example | Example | Example | Example | Example | Example |
|---|---|---|---|---|---|---|---|
| | 1 | 2 | 3 | 4 | 5 | 6 | 7 |
| 925-955 nm (average): % | 2.0 | 1.0 | 4.3 | 6.3 | 10.8 | 50.2 | 23.2 |
| 965-985 nm (average): % | 0.9 | 0.4 | 1.9 | 2.4 | 4.6 | 30.4 | 11.1 |
| 400-800 nm (average): % | 88.2 | 88.2 | 87.9 | 88.5 | 87.8 | 87.4 | 87.9 |
| L_λ50 (half-value wavelength): nm | 885 | 883 | 888 | 889 | 890 | 935 | 897 |
| H_λ50 (half-value wavelength): nm | 1022 | 1024 | 1017 | 1016 | 1012 | 984 | 1002 |
| Liquidus temperature (LT): ° C. | 1200 | 1250 | 1200 | 1150 | 1150 | 1100 | 1150 |
| Powder-method water resistance (Dw): | 2 | 2 | 2 | 2 | 2 | 3 | 3 |
| class | | | | | | | |

| | Example | Example | Example | Example | Example | Example | Example |
|---|---|---|---|---|---|---|---|
| | 8 | 9 | 10 | 11 | 12 | 13 | 14 |
| 925-955 nm (average): % | 0.6 | 2.4 | 0.7 | 2.1 | 1.4 | 3.1 | 3.4 |
| 965-985 nm (average): % | 0.3 | 1.0 | 0.3 | 0.9 | 0.6 | 1.2 | 1.3 |
| 400-800 nm (average): % | 88.6 | 86.8 | 87.8 | 87.8 | 88.9 | 87.6 | 87.0 |
| L_λ50 (half-value wavelength): nm | 882 | 885 | 882 | 885 | 884 | 886 | 886 |
| H_λ50 (half-value wavelength): nm | 1026 | 1021 | 1026 | 1022 | 1023 | 1020 | 1019 |
| Liquidus temperature (LT): ° C. | 1350 | 1350 | 1350 | 1300 | 1300 | 1250 | 1200 |
| Powder-method water resistance (Dw): | 3 | 3 | 3 | 3 | 3 | 3 | 3 |
| class | | | | | | | |

| | Comparative | Comparative | Comparative |
|---|---|---|---|
| | Example 1 | Example 2 | Example 3 |
| 925-955 nm (average): % | 87.7 | — | — |
| 965-985 nm (average): % | 88.0 | — | — |
| 400-800 nm (average): % | 87.2 | — | — |
| L_λ50 (half-value | — | — | — |
| wavelength): nm | | | |
| H_λ50 (half-value | — | — | — |
| wavelength): nm | | | |
| Liquidus temperature | 1100 | — | — |
| (LT): ° C. | | | |
| Powder-method water | 2 | 3 | 3 |
| resistance (Dw): class | | | |

As shown in Tables 4 and 5, the optical glasses in Examples 1 to 14 were such that the average value (%) of the transmittance in the wavelength range of 925 to 955 nm is within the range of 0.6% to 50.2%, and the average value (%) of the transmittance in the wavelength range of 965 to 985 nm is within the range of 0.3% to 30.4%. The optical glasses in Examples 1 to 14 had a near-infrared absorbing function of selectively absorbing near-infrared rays in a 900 nm range (i.e., a band-stop filter function).

Also, the optical glass in Comparative Example 1 (Table 6) was such that the average value (%) of the transmittance in the wavelength range of 925 to 955 nm was 87.7%, and the average value (%) of the transmittance in the wavelength range of 965 to 985 nm was 88.0%. The optical glass in Comparative Example 1 (i.e., a glass in which the content of Yb₂O₃ was 0%) did not have a near-infrared absorbing function (i.e., a band-stop filter function). This indicates that it is preferable to set the lower limit value of the content of Yb₂O₃ to 5% (Example 6).

Also, the optical glass in Comparative Example 2 (i.e., a glass in which the content of Yb₂O₃ was 50%) devitrified. This indicates that it is preferable to set the upper limit value of the content of Yb₂O₃ to 45% (Example 9).

Incidentally, from tests by the present inventors, it has been found that the average transmittance in the wavelength range of 925 to 955 nm can be adjusted within the range of 0% to 70% and the average transmittance in the wavelength range of 965 to 985 nm can be adjusted within the range of 0% to 50% by adjusting the contents of Yb₂O₃ and other components.

Also, as shown in Tables 4 and 5, the optical glasses in Examples 1 to 14 were such that the average value (%) of the transmittance in the wavelength range of 400 to 800 nm was in the range of 87.4% to 88.9%. This indicates that constant and significantly high transmittance was maintained in a visible range. Incidentally, from tests by the present inventors, it has been found that the average value (%) in the wavelength range of 400 to 800 nm in Examples 1 to 14 can be adjusted within the range of 80% to 92% by adjusting the contents of components.

Also, as shown in Tables 4 and 5, the optical glasses in Examples 1 to 14 were such that the half-value wavelength at the point where the transmittance decreased to 50% (“L_λ50”: nm) was within the range of 882 to 935 nm, and the half-value wavelength at the point where the transmittance increased to 50% (“H_λ50”: nm) was within the range of 984 to 1026 nm. This indicates that the optical glasses could accurately cut off near-infrared rays in a 900 nm range (band stop). Incidentally, from tests by the present inventors, it has been found that the half-value wavelength at the point where the transmittance decreases to 50% (“L_λ50”: nm) can be adjusted within the range of 860 to 940 nm, and the half-value wavelength at the point where the transmittance increases to 50% (“H_λ50”: nm) can be adjusted within the range of 970 to 1040 nm by adjusting the contents of Yb₂O₃ and other components.

Also, comparing Example 8 and Comparative Example 3, it can be understood that the optical glass in Comparative Example 3 (i.e., a glass in which the content of Li₂O is 0%), which devitrifies, can contain 1% of Li₂O to increase the content of Yb₂O₃ to 41% (Example 8). Incidentally, from tests by the present inventors, it has been found that the content of Yb₂O₃ can be 30% or more by adjusting the content of the alkali metal(s) (Li₂O, K₂O, Na₂O).

Also, from “liquidus temperature (LT): ° C.” in Tables 4 and 5, it can be understood that “liquidus temperature (LT): ° C.” of each of the optical glasses in Examples 1 to 14 is 1350° C. or less (i.e., stable) and that the optical glass does not easily devitrify when manufactured.

Also, from “powder-method water resistance (Dw): class” in Tables 4 and 5, it can be understood that “powder-method water resistance (Dw): class” of each of the optical glasses in Examples 1 to 14 is class 3 or lower and that the glass has a sufficient chemical durability for an optical glass.

As described above, the optical glasses in Examples 1 to 14 have a glass composition as a base containing at least Yb₂O₃ and B₂O₃ as essential components, have such spectral transmission characteristics that the transmittance is maintained constant and high in the wavelength range of 400 to 800 nm and abruptly attenuate in a 900 nm range, and also have sufficient stability and chemical durability for an optical glass.

Thus, when the optical glass according to the present embodiment (Examples 1 to 14) is used, for example, for a near-infrared cut filter, it can be used as an optical filter (infrared cut filter) for blocking a laser beam from a LiDAR system.

Also, by using the optical glass according to the present embodiment (Examples 1 to 14) for a glass element for press molding, an optical element blank, and an optical element, it is also possible to provide a glass element for press molding, an optical element blank, and an optical element for blocking a laser beam from a LiDAR system.

While embodiments and examples of the present invention have been described above, the present invention is not limited to the above-described constitutions, and various modifications are possible within the technical scope of the present invention.

Also, the embodiments disclosed this time are exemplary in all respects and are not to be construed as limitations. The scope of the present invention is defined by the claims, not by the above description. All modifications falling within meanings and scopes equivalent to the scope of the claims are intended to be covered.

1. An optical glass including a glass composition as a base containing at least Yb₂O₃ and B₂O₃ as essential components, the optical glass characterized in that
a content of Yb₂O₃ is 5% to 60% by mass,
a content of B₂O₃ is 10% to 50% by mass, and
when a thickness of the optical glass is 2.5 mm,
average transmittance in a wavelength range of 925 to 955 nm is 0% to 70%, and
average transmittance in a wavelength range of 965 to 985 nm is 0% to 50%.

2. The optical glass according to claim 1, characterized in that average transmittance in a wavelength range of 400 to 800 nm is 80% to 92%.

3. The optical glass according to claim 1, characterized in that a first wavelength at a point on a spectral transmittance curve of the optical glass where transmittance decreases to 50% is 860 to 940 nm, and a second wavelength at a point on the spectral transmittance curve where the transmittance increases to 50% is 970 to 1040 nm.

4. The optical glass according to claim 1, characterized in that the thickness of the optical glass is 0.5 to 5.0 mm.

5. The optical glass according to claim 1, characterized in that a liquidus temperature of the optical glass is 1350° C. or less.

6. The optical glass according to claim 1, characterized in that powder-method water resistance of the optical glass is class 1, 2, or 3.

7. The optical glass according to claim 1, characterized in that the glass composition contains
SiO₂: 1 to 30%,
Al₂O₃: 0 to 15%
MgO: 0 to 10%,
CaO: 0 to 20%,
SrO: 0 to 10%,
BaO: 0 to 25%,
ZnO: 0 to 25%,
TiO₂: 0 to 15%,
Nb₂O₅: 0 to 15%,
Ta₂O₅: 0 to 15%,
WO₃: 0 to 10%,
ZrO₂: 0 to 10%,
La₂O₃: 0 to 30%,
Y₂O₃: 0 to 30%,
Gd₂O₃: 0 to 30%,
Sb₂O₃: 0 to 0.05%, and
SO₃: 0 to 0.3% in terms of % by mass.

8. The optical glass according to claim 7, characterized in that the optical glass further contains at least one of Li₂O, Na₂O, and K₂O such that a total content thereof is within a range of more than 0% to 10% by mass or less.

9. The optical glass according to claim 8, characterized in that the content of Yb₂O₃ is 30% by mass or more.

10. The optical glass according to claim 7, characterized in that a ratio of the content of Yb₂O₃ to a total of a Ln₂O₃ component (Ln is one or more selected from the group consisting of Yb, La, Y, and Gd) is 0.6 to 1.0.

11. A near-infrared cut filter comprising the optical glass according to claim 1.

12. A glass element for press molding comprising the optical glass according to claim 1.

13. An optical element blank comprising the optical glass according to claim 1.

14. An optical element comprising the optical glass according to claim 1.
